(19) United States
(12) Patent Application Publication
(10) Pub. No.: US 2014/0176060 A1
(43) Pub. Date: Jun. 26, 2014

(54) Miniature Low-Power Remote Battery Charging Systems and Methods

(71) Applicant: Resonate Industries, Inc., Westlake Village, CA (US)

(72) Inventors: Vatche VORPERIAN, Irvine, CA (US); Leon ALKALAI, Studio City, CA (US); Donald HUNTER, La Verne, CA (US); Du LI, Oak Park, CA (US); Noam LOTAN, Westlake Village, CA (US)

(21) Appl. No.: 13/934,165

(22) Filed: Jul. 2, 2013

Related U.S. Application Data
(60) Provisional application No. 61/666,969, filed on Jul. 2, 2012.

(51) Int. Cl. H02J 7/02; H02J 7/00

(52) U.S. Cl. CPC H02J 7/025; H02J 7/0052
USPC 320/108; 320/137

(57) ABSTRACT

In some embodiments, the charging magnetic field produced in an air gap within an inductive charger for a hearing aid or other miniature device is shaped by lateral protrusions, which draw the magnetic field away from a body of a device battery situated behind a receiver inductor. Shaping the magnetic field allows reducing the magnetic field flux intercepted by the battery (rater than the receiver inductor), reducing the inductive heating of the battery. A charging element produces a high-frequency, ˜120 kHz, magnetic field inside the gap in which the hearing aid or other device is inserted to charge its battery. A loosely-coupled magnetic transformer circuit forms a resonant tank circuit that is excited, by a feedback control circuit, at its resonant frequency to ensure power transfer across the large gap regardless of the dimensional variations of the gap and the relative position of the hearing aid in the gap.

### RELATED APPLICATION DATA

This application claims the benefit of the filing date of U.S. Provisional Patent Application No. 61/666,969, filed Jul. 2, 2012, first inventor Vorperian, entitled “Miniature Low-Power Remote Battery Charging Systems Using Loosely-Coupled Resonant Circuits,” which is herein incorporated by reference.

### BACKGROUND

The disclosure is related to wireless charging of rechargeable batteries of miniature devices such as hearing aids, and in particular to wireless power transmission using high-frequency resonant power conversion techniques.

Wireless transmission of low power, of the order of a few milliwatts, into miniature devices such as hearing aids, of the order of several millimeters across and tall, faces particular constraints. In particular, wireless charging may be particularly difficult under such tight spatial constraints if the primary and secondary inductors are loosely-coupled, for example through an air gap rather than a common core, and if the relative positioning of the primary and secondary inductors is not precisely fixed.

### DESCRIPTION OF THE DRAWINGS

FIG. 1-A shows an exemplary hearing aid according to some embodiments of the present invention.

FIG. 1-B shows an exemplary hearing aid battery charger according to some embodiments of the present invention.

FIG. 1-C shows an exemplary system comprising a hearing aid placed within a charger according to some embodiments of the present invention.

FIG. 2-A shows an exemplary battery configuration within a hearing aid with the battery negative terminal facing a receiver inductor, according to some embodiments of the present invention.

FIG. 2-B shows an exemplary battery configuration within a hearing aid with the battery positive terminal facing a receiver inductor, according to some embodiments of the present invention.

FIGS. 3-A-B show exploded isometric and top plan views, respectively, of a multilayer PCB receiver inductor according to some embodiments of the present invention.

FIG. 4 shows an isometric view of an exemplary printed circuit board supporting receiver charging electronic components according to some embodiments of the present invention.

FIG. 5-A shows a circuit diagram of an exemplary charging circuit according to some embodiments of the present invention.

FIG. 5-B shows a circuit diagram of an exemplary primary charging circuit according to some embodiments of the present invention.

FIG. 5-C shows a circuit diagram of an exemplary secondary charging circuit according to some embodiments of the present invention.

FIGS. 6-A-B show top and side views, respectively, of a wireless charging system suitable for simultaneously charging two hearing aids, according to some embodiments of the present invention.

FIG. 7 shows an exemplary dual-hearing aid charging system having rounded field-shaping lateral protrusions according to some embodiments of the present invention.

### SUMMARY

According to one aspect, a system comprises a remote battery charger comprising a transmitter inductor electrically connected to an external power source, and a hearing aid removably situated within a charging chamber of the remote battery charger. The hearing aid comprising a rechargeable hearing aid battery body and a receiver inductor electrically connected to the battery body. The receiver inductor is inductively coupled to the transmitter inductor through a generally-longitudinal air gap. The battery body is disposed opposite the transmitter inductor relative to the receiver inductor. The remote battery charger comprises a set of lateral field-shaping protrusions disposed laterally with respect to the receiver inductor. The field-shaping protrusions direct a charging magnetic field generated by the transmitter inductor away from a central axis of the battery body so as to decrease an inductive coupling of the transmitter inductor to the battery body.

According to another aspect, a method comprises removably placing a hearing aid inside a charging chamber of a remote battery charger, the charger comprising a transmitter inductor electrically connected to an external power source, the hearing aid comprising a rechargeable hearing aid battery body and a receiver inductor electrically connected to the battery body, the receiver inductor being inductively coupled to the transmitter inductor through a generally-longitudinal air gap, the battery body being disposed opposite the transmitter inductor relative to the receiver inductor; and charging the rechargeable battery by inductively coupling energy from the transmitter inductor to the receiver inductor. The remote battery charger comprises a set of lateral field-shaping protrusions disposed laterally with respect to the receiver inductor, the field-shaping protrusions directing a charging magnetic field generated by the transmitter inductor away from a central axis of the transmitter inductor so as to decrease an inductive coupling of the transmitter inductor to the battery body.

According to another aspect, a system comprises a remote battery charger comprising a transmitter inductor electrically connected to an external power source; a rechargeable battery body situated within a charging chamber of the remote battery charger; and a receiver inductor electrically connected to the battery body and situated between the transmitter inductor and the battery body, the receiver inductor being inductively coupled to the transmitter inductor through a generally-longitudinal air gap. The remote battery charger comprises a set of lateral field-shaping protrusions disposed laterally with respect to the receiver inductor, the field-shaping protrusions directing a charging magnetic field generated by the transmitter inductor away from a central axis of the transmitter inductor so as to decrease an inductive coupling of the transmitter inductor to the battery body.

According to another aspect, a method comprises placing a rechargeable battery body within a charging chamber of a remote battery charger, the remote battery charger comprising a transmitter inductor electrically connected to an external power source, the battery body being electrically connected to a receiver inductor situated between the transmitter inductor and the battery body, the receiver inductor being inductively coupled to the transmitter inductor through a generally-longitudinal air gap; and charging the rechargeable battery by inductively coupling energy from the transmitter inductor to the receiver inductor. The remote battery charger comprises a set of lateral field-shaping protrusions disposed laterally with respect to the receiver inductor, the field-shaping protrusions directing a charging magnetic field generated by the transmitter inductor away from a central axis of the transmitter inductor so as to decrease an inductive coupling of the transmitter inductor to the battery body.

According to another aspect, a remote hearing-aid battery charging system comprises a charging chamber sized to receive a hearing aid for recharging a battery of the hearing aid; and a transmitter inductor configured to emit a radio-frequency charging magnetic field along a generally longitudinal direction through an air gap between the transmitter inductor and a location of a receiver inductor electrically connected to the battery. The charging chamber comprises a set of lateral field-shaping protrusions disposed laterally with respect to the transmitter inductor, the field-shaping protrusions directing the charging magnetic field generated by the transmitter inductor away from a central axis of the transmitter inductor so as to decrease an inductive coupling of the transmitter inductor to the battery.

### DESCRIPTION OF EXEMPLARY EMBODIMENTS

The following description illustrates the present invention by way of example and not necessarily by way of limitation. Any reference to an element is understood to refer to at least one element. A set of elements is understood to include one or more elements. A plurality of elements includes at least two elements. Any recited connection is understood to encompass a direct operative connection or an indirect operative connection through intermediary structure(s). The terms “electronic battery” and “dynamic battery” are used to refer to batteries including a battery body (battery cell) integrated together with a charging circuit in a battery-sized structure. Unless otherwise specified, the term “battery” encompasses both electronic batteries and conventional batteries (i.e. battery cells not integrated with a charging circuit).

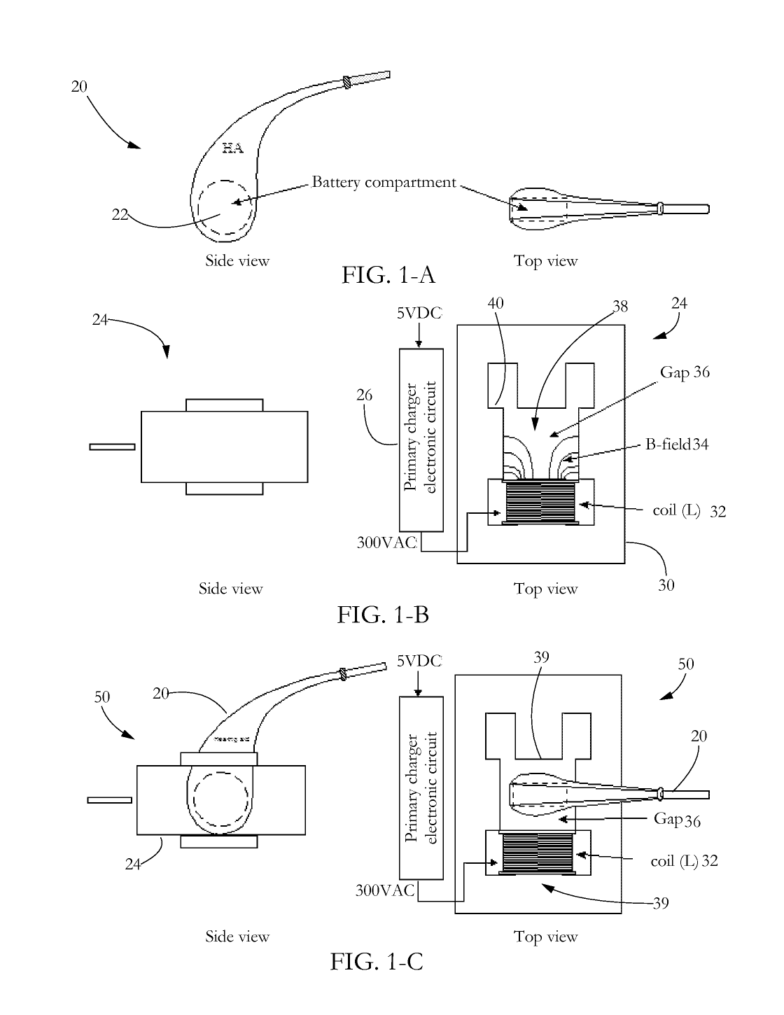

FIG. 1-A shows side and top views of an exemplary hearing aid 20 according to some embodiments of the present invention. Hearing aid 20 is sized to fit in a user's ear. Hearing aid 20 includes a battery compartment 22 configured to receive a rechargeable battery which can be charged wirelessly while situated within hearing aid 20, as described below.

In some embodiments, the rechargeable battery is an electronic (dynamic) battery including a conventional battery body integrated together with a charging circuit including a receiver inductor. Such a rechargeable electronic battery may be sized as a standard-size zinc-air battery commonly used for hearing aids. In some embodiments, the rechargeable battery may be a conventional (non-electronic) battery electrically connected to a charging circuit (e.g. a charging circuit separately provided as part of the hearing aid), but not physically integrated with the charging circuit into a standard battery-sized structure.

FIG. 1-B shows side and top views of a wireless battery charger 24 suitable for receiving a hearing aid to wirelessly charge the hearing aid battery situated within the hearing aid, according to some embodiments of the present invention. FIG. 1-C shows a charging system 50 formed by placing hearing aid 20 within charger 24.

As shown in FIG. 1-B, charger 24 includes a charging body 30 enclosing a charging chamber 38. Charging body 30 may form a magnetic core, which is inductively coupled to a primary inductor (coil) 32. Charging body/magnetic core 30 may be formed from a conductive, magnetic material such as ferrite. A lower longitudinal conductive protrusion (leg) 39 defined within charging chamber 38 forms a magnetic core of primary inductor 32, while an oppositely-facing longitudinal protrusion (leg) 39 limits the size of charging chamber 38.

A primary charger electronic circuit 26 is electrically connected to an external power source (e.g. a transformer drawing power from the electrical grid or a car battery), and to a primary (transmitter) charging inductor (coil) 32 situated within charging chamber 38. Primary inductor 32 generates a radio-frequency (RF) charging magnetic field 34 extending in a generally-longitudinal direction (vertical in FIGS. 1-B-C), within an air gap 36 defined between primary inductor 32 and hearing aid 20. The alternating charging magnetic field may have a frequency on the order of 100 kHz, for example about 120 kHz.

A set of one or more lateral conductive field-shaping protrusions (legs) 40 protrude laterally within charging chamber 38, and serve as poles directing the charging magnetic field away from a central axis primary inductor 32 (which coincides with a central axis of a battery body inserted within charging chamber 38), so as to decrease an inductive coupling of primary inductor 32 to the battery body. Field-shaping protrusions 40 are disposed laterally with respect to the receiver inductor connected to the battery situated within charging chamber 38. In the exemplary configuration of FIG. 1-B, two oppositely-facing field-shaping protrusions 40 are used; in some embodiments, one or more than two lateral field-shaping protrusions may be used. Field-shaping protrusions 40 protrude inside relative to the portion of the side wall of charging chamber 38 along primary inductor 32. In some embodiments the lateral extent of field-shaping protrusions 40 may be on the order of mm, for example about 1-10 mm, as measured from the side of wall of charging chamber 38 along primary inductor 32. In some embodiments, the lateral extent of field-shaping protrusions 40 extending over primary inductor 32 may be on the order of a few mm, e.g. 1-2 mm.

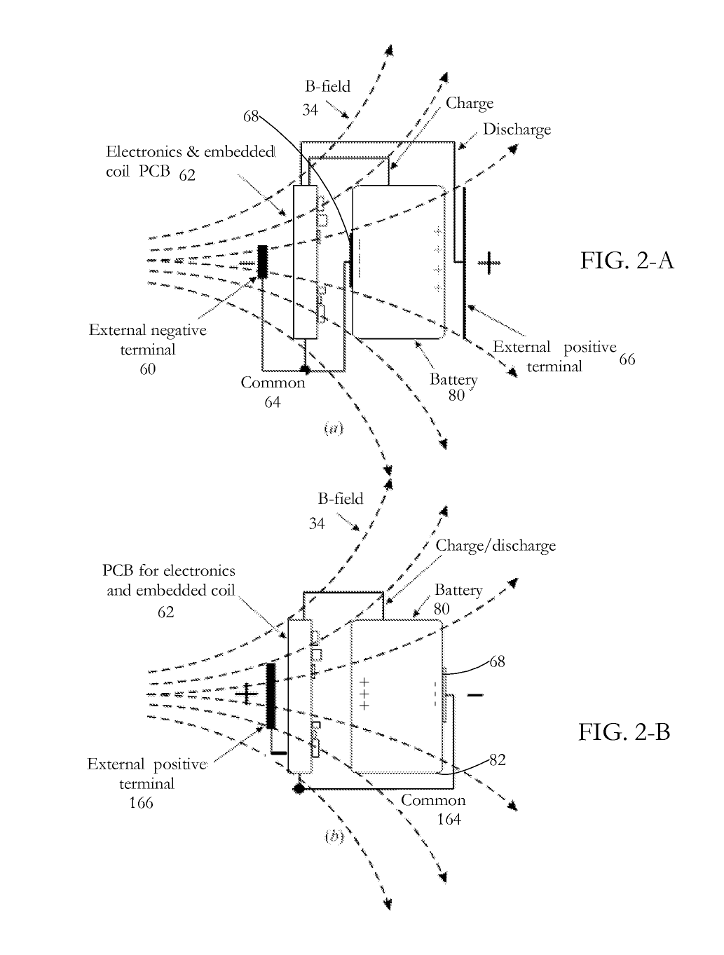

FIG. 2-A shows an exemplary battery configuration within a hearing aid with the battery negative terminal facing a receiver inductor, according to some embodiments of the present invention. A battery (battery body) 80 is electrically connected to a charging circuit 62 which includes a receiver inductor (coil) and energy-harvesting circuit components mounted on a printed circuit board (PCB). As shown, battery body 80 is disposed opposite the transmitter inductor (the source of magnetic field 34) relative to the receiver inductor of charging circuit 62. Ideally, the charging magnetic field is mostly incident on (intercepted by) the receiver inductor, and only minimally incident on battery body 80, so as to reduce an inductive heating of battery body 80.

An external negative terminal 60 and an external positive terminal 66 are connected to the hearing aid circuitry, for powering the hearing aid. In some embodiments, external negative terminal 60 is at ground, while external positive terminal 66 is at 1.1 V, a voltage value used in legacy hearing aids. In some embodiments, the positive terminal of battery body 80 is at a different voltage (e.g. 4.2 V), and circuitry within charging circuit 82 down-converts the battery voltage to the needed external voltage. A negative battery contact 68 protrudes longitudinally from battery body 80. In some embodiments, negative battery contact 68 is shaped like a button extending nearly to the edge of battery body 80, and is surrounded by a rounded shoulder at the edge of battery body 80.

In the arrangement of FIG. 2-A, the battery negative terminal (the anode during battery operation) faces charging circuit 62 and its receiver inductor, and the battery positive terminal (the cathode during battery operation) faces away from the receiver inductor. The battery negative terminal is commonly connected with external negative terminal 60 to form a common node 64, which may be at ground. External positive terminal 66 is connected to the positive terminal of battery body 80 through charging circuit 62. In some embodiments, the external side of the printed circuit board supporting charging circuit 62 (the left side in FIG. 2-A) is shaped to include a rounded shoulder and central protruding button sized to fit within a hearing aid cradle configured complementarily to receive a standard hearing aid battery.

FIG. 2-B shows an exemplary battery configuration within a hearing aid with the battery positive terminal facing a receiver inductor, according to some embodiments of the present invention. The battery negative terminal 68 and external (hearing aid) negative terminal are commonly connected to form a common node 164, which may be at ground. An external positive terminal 166 is connected to the hearing aid circuitry and to charging circuit 62. Charging circuit 82 is further electrically connected to the positive terminal of battery body 80.

In the configuration of FIG. 2-B, the protruding battery negative terminal 68 and its surrounding rounded shoulder 82 can fit within a hearing aid cradle shaped complementarily so as to receive a conventional hearing aid battery.

In some embodiments, battery body 80 and charging circuit 62 are integrated together by a wrapping structure or assembly to form a standard-sized removable electronic battery. For example, a size 223 rechargeable Li-ion battery body may be mechanically integrated with a charging circuit PCB to form a size 13 lookalike Li-ion battery that can be placed in any hearing aid device. In some embodiments, charging circuit 62 may be fixed and provided as part of the hearing aid, and need not be physically (mechanically) integrated with removable battery body 80.

In some embodiments, the power transferred into battery body 80 through the receiver inductor of charging circuit 62 is on the order of 10 mW, for example a few mW to tens of mW. In some embodiments, the power transferred from the transmitted inductor has a value between 100 mW and 1 W, for example a few hundreds of mW. In some embodiments, the charging field has a frequency on the order of 100 kHz, for example tens of kHz to hundreds of kHz, more particularly about 100 kHz to 150 kHz.

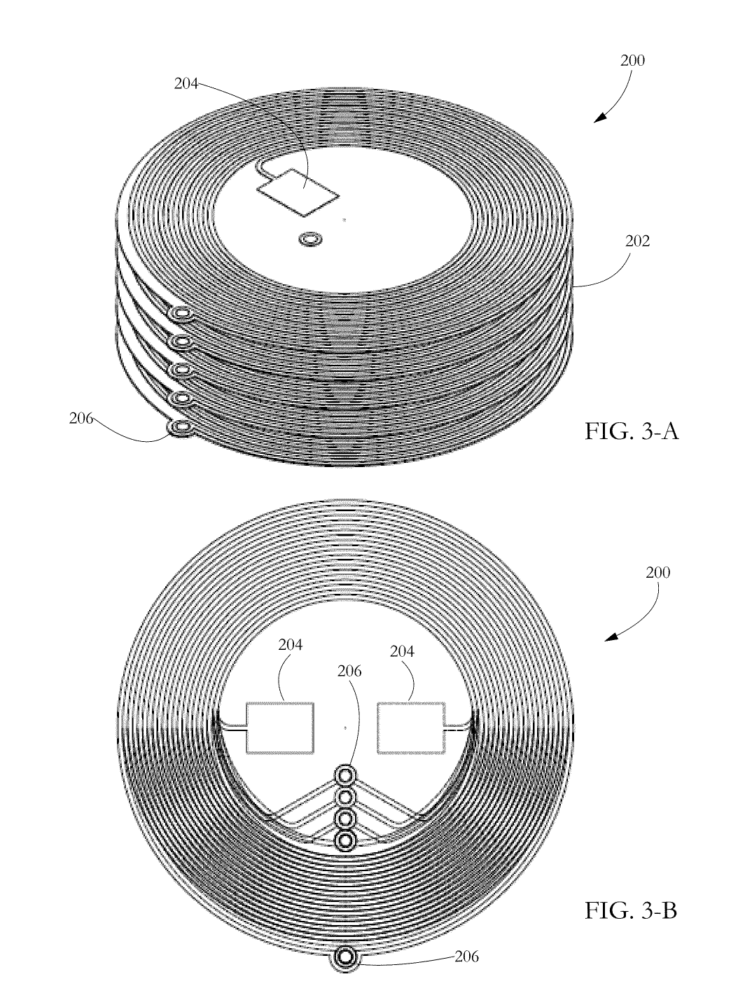

FIGS. 3-A-B show exploded isometric and top plan views, respectively, of a multilayer PCB receiver inductor (coil) 200 according to some embodiments of the present invention. Receiver inductor 200 includes a spiral conductive trace extending over multiple stacked layers 202: a conductive spiral in each layer is connected to one or two spirals in adjacent layers (above and/or below) through conductive vias (inter-layer connectors). Receiver inductor 200 includes two coil terminals 204 defined at the opposite ends of the conductive trace, as well as a plurality of test terminals 206 defined along each of the stacked layers. Test terminals 206 may be used to test the integrity of segments of the conductive trace. In some embodiments, the inductance and equivalent series resistance of receiver inductor 200 are on the order of tens to hundreds of pH and tens to hundreds of Ω, respectively (e.g. about 100 μH and 60Ω, respectively).

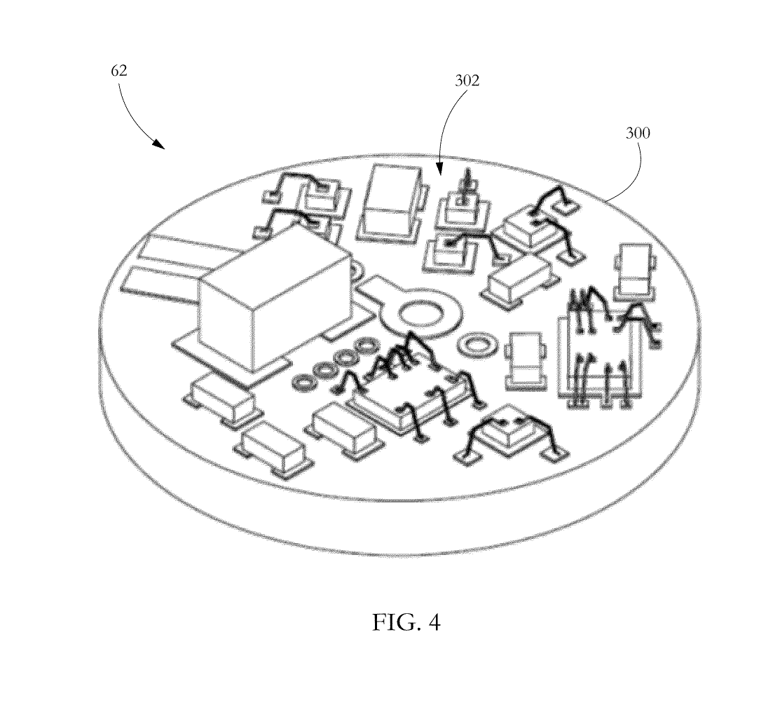

FIG. 4 shows an isometric view of an exemplary printed circuit board (PCB) 300 supporting receiver charging circuit 62 and its electronic components 302 according to some embodiments of the present invention. PCB 300 may include multiple layers, for example one layer supporting various electronic components 302 such as capacitors, resistors, and integrated circuits (chips), and a second layer incorporating a receiver inductor as shown in FIGS. 3-A-B.

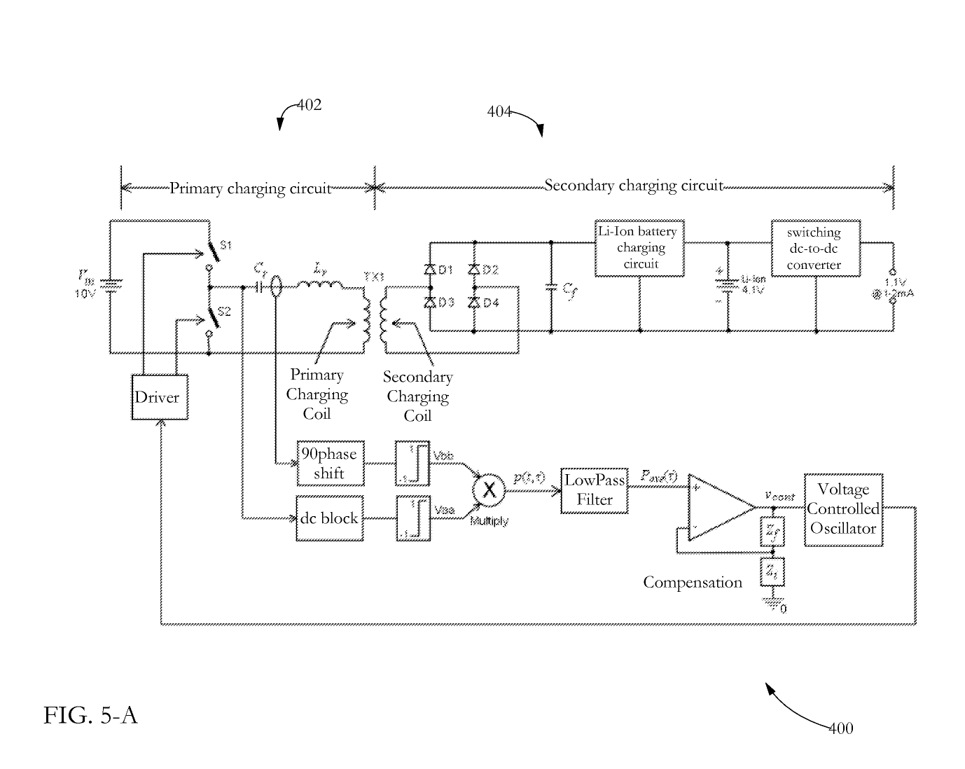

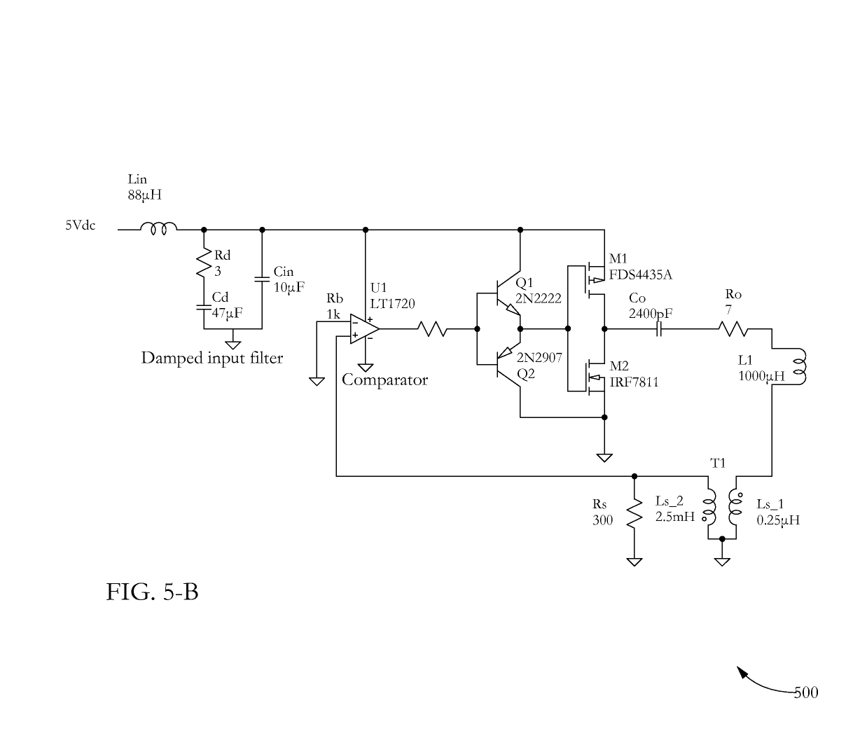

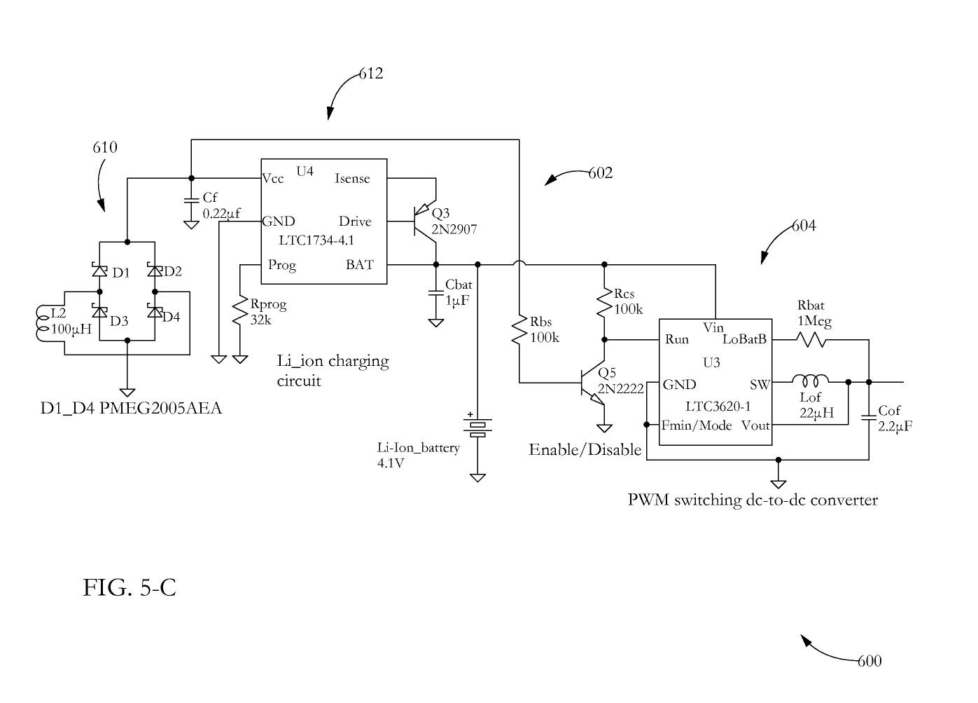

FIG. 5-A shows a circuit diagram of an exemplary charging (transformer) circuit 400 according to some embodiments of the present invention. Charging circuit 400 includes a primary (transmitter) circuit 402 and a secondary (receiver) circuit 404. Primary and secondary circuits 402, 404 are loosely-coupled inductively across an air gap as described above.

FIG. 5-B shows a circuit diagram of an exemplary primary charging circuit 500 according to some embodiments of the present invention. Primary charging circuit 500 is used to generate a high-frequency charging magnetic field using a transmitter inductor L₁.

FIG. 5-C shows a circuit diagram of an exemplary secondary (receiver) charging circuit 600 according to some embodiments of the present invention. Secondary charging circuit 600 uses a receiver inductor L₂ to receive the charging magnetic field generated by transmitter inductor L₁. A battery-charging circuit 602 charges the battery cell using the received energy. A dc-to-dc converter 604 converts between the voltages used by the battery cell and external hearing aid circuitry. Secondary charging circuit 600 and primary charging circuit 500 are separated by the physical gap between the loosely-coupled primary inductor L₁ and secondary inductor L₂.

In some embodiments, the voltage induced on the received inductor L₂ is applied to a full-wave rectifier 610 which produces a direct current 5-7 Vdc that powers a 4.1V or 4.2V Li-ion battery-charging control integrated circuit 612. Converter 604 may include a switching dc-to-dc buck regulator which converts the battery voltage of 4.1 or 4.2 Vdc to 1.1 Vdc needed to operate a legacy hearing aid. Full-wave rectifier 610, charging IC 612, and dc-to-dc converter 604 and their associated components may be mounted on the same printed circuit board, as illustrated in FIG. 4.

In some embodiments, the induced voltage across L₂ is applied to the full-wave bridge rectifier 610, whose output in turn is applied to a lithium-ion battery charging integrated circuit 612, which may be a LTC1734-4.1 chip. The magnitude of the induced dc voltage is a function of the distance between L₂ and L₁ and the voltage applied to L₁, both of which may be adjusted empirically so that the output voltage of the full-wave rectifier bridge 610 does not exceed a predetermined value, e.g. 7 Vdc. Once the battery is fully charged, charging IC 612 may automatically shift from a fast charging rate to a low rate. The exemplary values of the components shown may be based on the manufacturer's specifications and may be adjusted empirically to produce a maximum safe charging current into the battery, e.g. approximately 2-3 mA. A dc-to-dc converter chip LT3620-1 is used to convert the battery voltage to 1.1 Vdc, which is the voltage needed to operate the hearing aid. The values of the inductor and capacitor at the output of the LT3620-1 may be those recommended by the manufacturer. In some embodiments, as long as the hearing aid is in the charging gap and a voltage is present at the output of the full-wave rectifier 610, the shutdown pin on LT3620-1 is held low in order to prevent the dc-to-dc converter from operating. Once the hearing aid is taken out of the gap, the dc-to-dc converter becomes operational.

The operation of primary charger circuit 500 according to some embodiments may be better understood by considering the following description in conjunction with FIG. 5-B. A pair of complementary MOSFETs (M₁ and M₂), driven symmetrically with 50% duty-cycle excite the resonant branch comprising C_{O}, and the loosely coupled inductors L₁ and L₂ with a unipolar pulse train of amplitude Vᵢₙ. The resonant capacitor blocks the dc component of the input voltage, Vᵢₙ/2, so that the resonant circuit is effectively excited by a symmetrical square wave, νₑ (t), of amplitude equal to Vᵢₙ/2.

The resonant frequency is given by:

$${f}_{0} = \frac{1}{2 π \sqrt{{C}_{o} {L}_{σ}}} \qquad ( 1 )$$

In Equation (1), L_{σ} is the leakage inductance which is related to the self inductance of the primary charging coil, L₁, and secondary receiving coil, L₂, by the coupling coefficient, k, as:

$${L}_{σ} = {L}_{1} ( 1 - k \sqrt{\frac{{L}_{2}}{{L}_{1}}} ) \qquad ( 2 )$$

If k<<1 and L₂<<L₁, then L_{σ}≈L₁, and consequently the resonant frequency is given to an excellent approximation by:

$${f}_{0} \approx \frac{1}{2 π \sqrt{{C}_{o} {L}_{1} )}} \qquad ( 3 )$$

The coupling coefficient k, may inherently have a very small value if L₂ is physically much smaller than L₁ and the two do not share a common magnetic core. In fact as we have seen, L₁ may be an inductor with an air core. In some embodiments, the value of the coupling coefficient is on the order of 0.1, more particularly less than 0.2, more particularly approximately 0.1:

k≈0.1 (4)

With such a low value of the coupling coefficient, power transfer to L₂ may become problematic because a high voltage must be applied to the primary coil in order to induce a small voltage on the secondary. In exemplary embodiments, the ratio of the voltage at the output of L₂ to the voltage applied to L₁ using typical values is given by:

$$\frac{{V}_{L 2}}{{V}_{L 1}} = k \sqrt{\frac{{L}_{2}}{{L}_{1}}} = 0.1 \sqrt{\frac{100 μ H}{1000 μ H}} = 0.0316 \qquad ( 5 )$$

To obtain the necessary high voltage on L₁ starting with a 5 Vdc source, L₁, Cₒ and the MOSFETs M₁ and M₂ form a high-Q resonant circuit which is excited at its resonant frequency. In order to ensure that the circuit is always excited at its resonance, a simple positive feedback loop may be implemented as shown in FIGS. 5-A-B. In this loop, the resonant current is sensed by the 1:100 transformer T₁ (FIG. 5-A) and converted to a voltage across Rₛ, which is applied to a comparator referenced to ground (LT1720 in FIG. 5-A). The comparator turns on M₁ and turns off M₂ each time the current turns positive and vice-versa when the current turns negative. This ensures sustained oscillations at the resonant frequency but does not guarantee that the circuit will start oscillating. If an antenna is placed at the positive pin of the comparator, the circuit will start oscillating by the slightest disturbance, such as power on, because of its high-Q.

The operation of the transformer circuit in some embodiments may be better understood by considering the following description of the equations for the resonant current and voltage in terms of the Q-factor of the resonant circuit.

The characteristic impedance, Zₒ, and the Q-factor may be given by those of a simple series resonant circuit, L₁, Cₒ and Rₒ as follows:

$$\begin{matrix}{Z}_{o} = \sqrt{\frac{{L}_{1}}{{C}_{o}}} & ( 6 ) \\ Q = \frac{{Z}_{o}}{{R}_{o}} & ( 7 )\end{matrix}$$

In Eq. (7), Rₒ represents the total losses in the resonant circuit which lower the Q-factor of the resonant tank. The factors contributing to Rₒ are the winding resistance of the primary coil, r_{L1}, the equivalent series resistance, r_{Co}, of the resonant capacitor Cₒ, the on-resistance, r_{DS}, of the MOSFETs, M₁ and M₂, the core losses of the magnetics circuit, r_{core}, and the losses due to induction heating, r_{q}, of the electronic battery and the hearing aid. The induction heating losses may be particularly important because they are present only when the hearing aid is inserted in the charger. In fact, insertion of the hearing aid in the gap may cause the resonant current to drop by about 20-25%. When the resonant circuit is designed, the components of Rₒ may be chosen so that the resultant resonant current, which produces the induction field, is sufficient to induce the necessary voltage across L₂ to charge the electronic battery. A Q-factor in the range 75-100 was obtained in an exemplary prototype implementation of a rechargeable battery system circuit as described above.

With a high Q-factor and the frequency of the pulse train νₑ (t) equal to the resonant frequency, the magnitude of the resonant current may be almost entirely determined by the fundamental component of νₑ (t) which is given by 2Vᵢₙ/π. Hence the resonant current may be given by:

$${I}_{o} = {I}_{p} sin ( {ω}_{0} t ) = \frac{{V}_{in}}{{Z}_{o}} \frac{2}{π} Q sin ( {ω}_{0} t ) \qquad ( 8 )$$

The resonant voltage, which appears across L₁ and Cₒ may be given by:

$${V}_{o} = {V}_{p} sin ( {ω}_{0} t ) = \frac{2 {V}_{in}}{π} Q sin ( {ω}_{0} t ) \qquad ( 9 )$$

Finally the voltage induced across the receiving coil, L₂, may be given by:

$${V}_{L 2} = k \sqrt{\frac{{L}_{2}}{{L}_{1}}} \frac{2 {V}_{in}}{π} Q sin ( {ω}_{0} t ) \qquad ( 10 )$$

The following are typical values for the various parameters in some embodiments:

L₁=1000 μH L₂=100 μtH k=0.1, Cₒ=2400 pF, Rₒ=8Ω (11)

Using these values we obtain:

$$\begin{matrix} {Z}_{o} = 745 Ω ; \\ {f}_{o} = 103 kHz ; \\ Q = 81 & ( 12 ) \\ {I}_{o} = \frac{5 V}{645 Ω} \frac{2}{π} 81 sin ( 2 π1 .03 \times {10}^{5} t ) = ( 400 mA ) sin ( 6.6 \times {10}^{5} t ) & ( 13 ) \\ {V}_{o} = \frac{2 \times 5 V}{π} 81 sin ( 6.6 \times {10}^{5} t ) = ( 260 V ) sin ( 6.6 \times {10}^{5} t ) & ( 14 ) \\ {V}_{L 2} = 0.1 \sqrt{\frac{100}{1000}} \frac{2 \times 5 V}{π} 81 sin ( {ω}_{0} t ) = ( 8.1 V ) sin ( 6.6 \times {10}^{5} t ) & ( 15 )\end{matrix}$$

Finally, an input LC filter, Lᵢₙ and Cᵢₙ, with a damping branch, R_{d} and C_{d}, may be used to filter out the switching resonant current so that a smooth dc current is drawn from the 5 Vdc source.

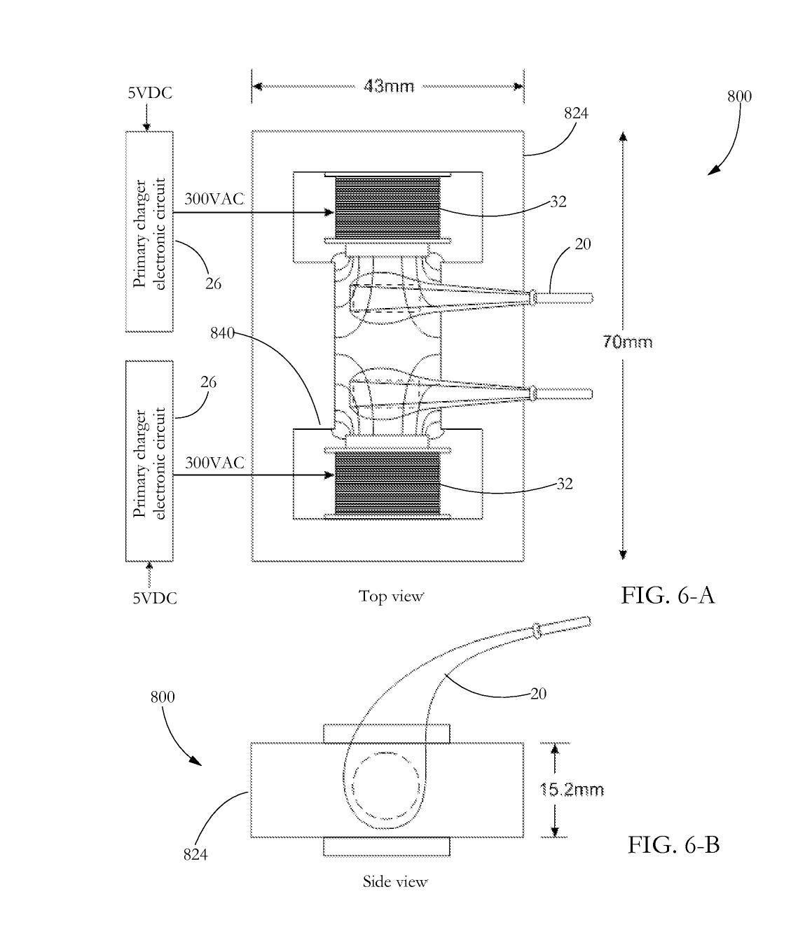

FIGS. 6-A-B show top and side views, respectively, of a wireless charging system 800 suitable for simultaneously charging two hearing aids 20, according to some embodiments of the present invention. Many hearing aid users have two hearing aids, and would benefit from a dual charger such as the one shown in FIGS. 6-A-B.

A charger 824 includes two oppositely-facing primary (transmitter) inductors 32, each configured to charge the battery within a corresponding hearing aid 20 placed in charger 824. One or more common field-shaping lateral protrusions 840 extend along both hearing aids 20, and serve to shape the charging magnetic fields generated by both transmitter inductors 32 as described above. Two longitudinal conductive protrusions extend within the charging chamber, and form the magnetic cores of primary inductors 32. Charger 824 may use a common magnetic core but two independent primary charging circuits 26 in order to eliminate the loading effect of one side on the other. In principle both coils can either be connected in series or in parallel and driven by a single primary charging circuit. But, because the presence of a hearing aid in the gap loads the primary charger, the charging current may depend whether there is one hearing aid or two aids in the charger. When dual drivers 26 are used this interaction can be eliminated.

In some embodiments, the thickness of each hearing aid 20 takes about 50-60% of the longitudinal extent (vertical extent in FIGS. 6-A-B) of field-shaping lateral protrusions (legs) 840. The adjacent four corners of the two longitudinal protrusions forming the cores of primary inductors 32 and the two lateral field-shaping protrusions 840 may be closely-spaced apart, e.g. within a few mm (e.g. 1-3 mm) of each other, in order to effectively to pull away the charging magnetic field laterally. The charging chamber may be kept as small as possible while still accommodating the hearing aid(s), since a larger charging gap may require stronger field sources, which may lead to higher power consumption and stronger electromagnetic interference.

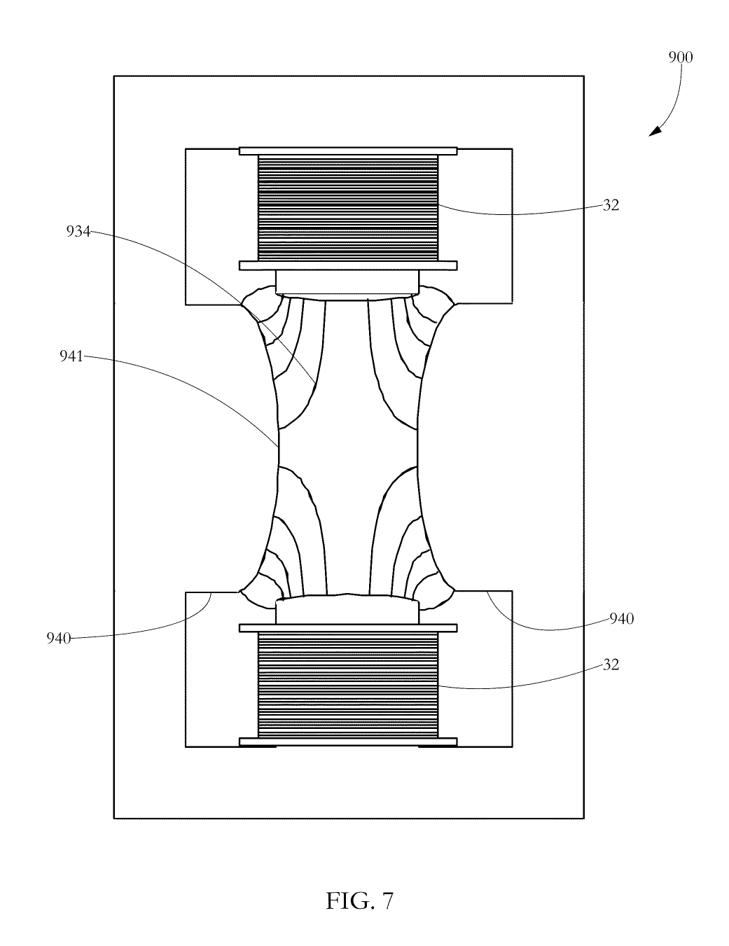

FIG. 7 shows an exemplary dual-hearing-aid charging system 900 having rounded field-shaping lateral protrusions 940 according to some embodiments of the present invention. The divergent magnetic fields shown in FIGS. 1-B-C and 6-A-B are generated by the shape of the magnetic core 30 in which the lateral protrusions 40, 840 on either side of the large gap pull the magnetic fields away. The magnetic circuit shown in FIGS. 1-B-C and 6-A-B may be made of standard ferrite parts which come in the form of squares, rectangles and cylinders. In some embodiments, a more optimal divergent field 934 can be produced if curvilinear edges 941 are used for four legs of the magnetic circuit as shown in FIG. 7. At the same time, exemplary experimental units have shown the adequacy of the magnetic circuits shown in FIGS. 1-B-C and 6-A-B in some embodiments.

Exemplary systems and methods as described above allow the reliable wireless charging of hearing aids or other miniature devices through an air gap, under tight spatial constraints. The restricted volume allowed for the reception of the transmitted power within these miniature devices benefits from the described magnetic circuits for laterally-shaping the magnetic field in the allowed volume without causing interference or damage to the device. Such damage may be caused by inductive heating of the battery.

Recognizing the weak coupling of a receiving coil inside a hearing aid device placed in a charging cradle, and a charging coil placed outside, the exemplary description above shows how a series resonant circuit can be formed from the loosely coupled coils and excited at its resonant frequency to overcome the weak coupling and obtain sufficient power transfer to charge the battery. Furthermore, because the resonant frequency depends on the relative position of the two coils and slight deviation of the excitation frequency from the resonant frequency can result in almost no power transfer, a feedback circuit with a voltage controlled oscillator may be used to lock-on to the resonant frequency of the series resonant circuit. In order to limit the induction to the receiving coil as much as possible without causing induction heating in the conductive casing of the battery or its chemical contents, the magnetic fields are shaped so that they are pulled out and away from the sides of the receiving coil immediately after they cross the area of the receiving coil. Finally, the excitation currents are kept low enough so that the escaped fields inside the battery do not cause significant heating or damage to the chemical composition.

Several practical constraints in some embodiments may lead to inherently a very low value of the coupling coefficient, k. First, the receiving coil ideally is small enough to fit inside the battery compartment of the hearing aid device and occupies a very small portion of the volume of the battery compartment in order to leave room for the battery. Second, the secondary coil is physically isolated from the primary coil and may not readily share a common ferrite core to obtain reasonable coupling to the primary. In fact, the secondary coil may be an air core formed by interconnecting spiral traces on a multilayer printed circuit board. Third, the dimensions of a physical configuration comprising a charging unit and a hearing aid device, containing the secondary coil, placed inside the charging unit constrain the distance between the secondary coil and any source of magnetic field, in the charging unit, that is comparable to the dimensions of the receiving coil. Thus, commonly the value of a coupling coefficient achievable through such an air gap is on the order of 0.1. If the power needed to charge a hearing aid battery is of the order of a few tens of milliwatts, an efficiency of a few percent will result in an input power of the order of one or two watts.

A legacy hearing aid configured to use standard-size zinc-air batteries may be equipped instead with an electronic battery as described above, placed inside the gap of a transformer-like primary charger magnetic circuit and charged by magnetic induction from an adjacent coil. Compared to inductive chargers used in electric toothbrushes, electric cars and charging plates for cell phone, the electronics and magnetic circuits described above are different at least because the transmitting and receiving coils in such applications are reasonably well coupled and the battery is not in inside the charging magnetic field. In contrast, an exemplary receiving coil as described above may be weakly coupled to the charging coil because it is a) on an air core, b) much smaller than the charging coil and c) comparatively at a significant distance from the charging coil. Also, the battery may be subject to induction heating if it is a short distance (e.g. 1 mm) away from the receiving coil and well inside the charging magnetic field.

The very weak coupling between the charging and receiving coils may require 300-to-600 Vac at ˜100 kHz be applied to the charging coil in order to induce 5-to-6V on the receiving coil. Such a high voltage can be readily obtained from a 5 Vdc source using a self-oscillating, high-Q resonant circuit in which the resonant inductor is the charging coil itself.

Common hearing aids (HA) available presently today operate on single-use, zinc-air batteries that last between 5-7 days depending on usage and power consumption of user selected sophisticated functions provided by the HA (such as Bluetooth, etc.). The procedure of replacing a depleted battery with a new battery is quite awkward and represents a significant amount of frustration and challenge especially for the average age group of HA users. The ability to seamlessly recharge a standard (legacy) HA without the hassle of replacing the battery has long been a sought after capability by HA providers and users alike. Exemplary technology and systems as described above provide just such a capability. Using high-frequency alternating magnetic fields to transfer energy wirelessly, a primary charging coil located within a primary charger housing structure, transfers energy to a secondary receiving coil embedded in the HA rechargeable battery, using loosely coupled resonant circuits.

In some embodiments, an electronic battery as described above includes three sub-parts: a rechargeable battery chemistry system such as a 4.1 V or 4.2 V Li-ion chemistry or other rechargeable battery chemistries; an electronic printed circuit board, which may be called the Remote Charging Electronics (RCE), that accommodates an embedded receiving coil, a full wave rectifier, a Li-ion charging integrated circuit and a switching dc-to-dc converter with 1.1 V output; and a small standard-size battery casing that houses the rechargeable battery chemistry and RCE described above.

In some embodiments, the primary charger comprises two parts: a magnetic circuit with two primary charging coils and a fixed, large gap; and an electronic printed circuit board with an oscillator that drives the two primary charging coils, one for each hearing aid, in the magnetic circuit. The printed circuit board accepts 5 Vdc from a standard micro USB port and produces a high frequency, ˜100 kHz, magnetic field inside the fixed gap in which one or two hearing aid devices, equipped with the electronic batter, are placed. The magnetic field in the gap induces a voltage in the embedded coil inside the Dynamic Battery which then energizes the electronic circuit that in turn charges the 4.1 V-4.2 V Li-ion battery.

Exemplary magnetic circuits as described above are designed so as to have the magnetic fields be mostly intercepted by the embedded inductor inside the RCE and not by the battery casing in order to prevent excessive heating in the battery caused by induction. The magnetic fields are pulled out and away from the sides of the receiving coil, after they cross the receiving coil, in order to limit the induction to the battery as much as possible and minimize induction heating in the conductive casing of the battery.

When the hearing aid is fully charged and removed from the gap, the Li-ion battery powers a switching dc-to-dc converter which converts the (4.1 or 4.2 volts of a Li-ion) battery voltage to an output voltage of 1.1V needed to operate standard (legacy) hearing aid device that are designed to operate with zinc-air batteries, which operate at 1.1 volts.

A full form-fit-function prototype as described above was built and tested in the field using a legacy (Phonak) hearing aid device for over 10 weeks without degradation, indicating the compatibility of exemplary charging systems as described above with legacy hearing aid devices.

It will be clear to one skilled in the art that the above embodiments may be altered in many ways without departing from the scope of the invention. Accordingly, the scope of the invention should be determined by the following claims and their legal equivalents.

What is claimed is:

1. A system comprising:
a remote battery charger comprising a transmitter inductor electrically connected to an external power source; and
a hearing aid removably situated within a charging chamber of the remote battery charger, the hearing aid comprising a rechargeable hearing aid battery body and a receiver inductor electrically connected to the battery body, the receiver inductor being inductively coupled to the transmitter inductor through a generally-longitudinal air gap, the battery body being disposed opposite the transmitter inductor relative to the receiver inductor;
wherein the remote battery charger comprises a set of lateral field-shaping protrusions disposed laterally with respect to the receiver inductor, the field-shaping protrusions directing a charging magnetic field generated by the transmitter inductor away from a central axis of the battery body so as to decrease an inductive coupling of the transmitter inductor to the battery body.

2. The system of claim 1, wherein the battery body and a charging circuit comprising the receiver inductor are integrated to form a rechargeable hearing aid battery.

3. The system of claim 1, wherein a coupling coefficient characterizing an inductive coupling between the transmitter inductor and the receiver inductor has a value on the order of 0.1.

4. The system of claim 1, wherein the coupling coefficient has a value of less than 0.2.

5. The system of claim 1, wherein the receiver inductor comprises a spiral trace formed along multiple layers of a multilayer printed circuit board.

6. The system of claim 1, wherein a power transferred into the rechargeable battery through the receiver inductor has a value one the order of 10 mW.

7. The system of claim 6, wherein a power transferred from the transmitter inductor has a value between 100 mW and 1 W.

8. The system of claim 1, wherein the charging magnetic field has a frequency on the order of 100 kHz.

9. The system of claim 1, wherein the hearing aid comprises a self-oscillating receiver circuit configured to lock onto a resonant frequency of a charging circuit comprising the transmitter inductor and the receiver inductor.

10. The system of claim 1, wherein the remote battery charger comprises a pair of transmitter inductors positioned on opposite longitudinal sides of the set of field-shaping protrusions, each transmitter inductor being configured to charge a corresponding hearing aid.

11. The system of claim 1, wherein each of the field-shaping protrusions has a generally-curved surface.

12. The system of claim 1, wherein a positive terminal of the battery body faces the receiver inductor.

13. A method comprising:
removably placing a hearing aid inside a charging chamber of a remote battery charger, the charger comprising a transmitter inductor electrically connected to an external power source, the hearing aid comprising a rechargeable hearing aid battery body and a receiver inductor electrically connected to the battery body, the receiver inductor being inductively coupled to the transmitter inductor through a generally-longitudinal air gap, the battery body being disposed opposite the transmitter inductor relative to the receiver inductor; and
charging the rechargeable battery by inductively coupling energy from the transmitter inductor to the receiver inductor;
wherein the remote battery charger comprises a set of lateral field-shaping protrusions disposed laterally with respect to the receiver inductor, the field-shaping protrusions directing a charging magnetic field generated by the transmitter inductor away from a central axis of the transmitter inductor so as to decrease an inductive coupling of the transmitter inductor to the battery body.

14. A system comprising:
a remote battery charger comprising a transmitter inductor electrically connected to an external power source;
a rechargeable battery body situated within a charging chamber of the remote battery charger; and
a receiver inductor electrically connected to the battery body and situated between the transmitter inductor and the battery body, the receiver inductor being inductively coupled to the transmitter inductor through a generally-longitudinal air gap;
wherein the remote battery charger comprises a set of lateral field-shaping protrusions disposed laterally with respect to the receiver inductor, the field-shaping protrusions directing a charging magnetic field generated by the transmitter inductor away from a central axis of the transmitter inductor so as to decrease an inductive coupling of the transmitter inductor to the battery body.

15. A method comprising:
placing a rechargeable battery body within a charging chamber of a remote battery charger, the remote battery charger comprising a transmitter inductor electrically connected to an external power source, the battery body being electrically connected to a receiver inductor situated between the transmitter inductor and the battery body, the receiver inductor being inductively coupled to the transmitter inductor through a generally-longitudinal air gap; and
charging the rechargeable battery by inductively coupling energy from the transmitter inductor to the receiver inductor;
wherein the remote battery charger comprises a set of lateral field-shaping protrusions disposed laterally with respect to the receiver inductor, the field-shaping protrusions directing a charging magnetic field generated by the transmitter inductor away from a central axis of the transmitter inductor so as to decrease an inductive coupling of the transmitter inductor to the battery body.

16. A remote hearing-aid battery-charging system comprising:
a charging chamber sized to receive a hearing aid for recharging a battery of the hearing aid; and
a transmitter inductor configured to emit a radio-frequency charging magnetic field along a generally longitudinal direction through an air gap between the transmitter inductor and a location of a receiver inductor electrically connected to the battery;
wherein the charging chamber comprises a set of lateral field-shaping protrusions disposed laterally with respect to the transmitter inductor, the field-shaping protrusions directing the charging magnetic field generated by the transmitter inductor away from a central axis of the transmitter inductor so as to decrease an inductive coupling of the transmitter inductor to the battery.
